(19) United States
(12) Patent Application Publication
(10) Pub. No.: US 2021/0330111 A1
(43) Pub. Date: Oct. 28, 2021

(54) Automated storage and pickup device for food products purchased by mail order via the Internet

(71) Applicant: Retail Robotics Sp. z o.o. Sp. K., Bielsko-Biala (PL)

(72) Inventors: Lukasz Nowinski, Bielsko-Biala (PL); Aleksander Gruca, Skawina (PL); Piotr Dawidczyk, Warszawa (PL); Julian Kozankiewicz, Warszawa (PL)

(21) Appl. No.: 17/239,421

(22) Filed: Apr. 23, 2021

(30) Foreign Application Priority Data
Apr. 27, 2020 (PL) P.433712

(51) Int. Cl. A47G 29/14; G06Q 10/08; G06K 7/14; G01G 3/14

(52) U.S. Cl. CPC A47G 29/14; G01G 3/1402; G06K 7/1434; G06Q 10/087

(57) ABSTRACT

A programmatically integrated cooling module and freezing module. In the cooling module, the front and rear racks with cantilever storage slots for transportation baskets are installed in parallel and have a spacing greater than the width of the transportation basket. In the vertical plane of symmetry between the racks, there is a Cartesian frame manipulator with a trolley and a gripping mechanism. The internal space of the cooling module is circulated with cooling air at a stabilised temperature in the range between 1° C. and 8° C. (optimally 4° C.), produced by a refrigeration unit. On the front wall of the cooling module housing, below the storage slots of the front rack, there are sending and collecting windows. The windows are designed as sluices with a drawer whose rear opening is periodically closed by a movable rear partition and which at the front has a single-leaf door hinged vertically and locked by an electromagnetic lock. In the freezing module, lockers have walls perforated with holes and the number of the order currently available for pickup is illuminated on the door.

### BACKGROUND

This invention relates to an automated storage and pickup device for food products purchased by mail order via the internet, used in e-retail as an alternative to purchases carried out with delivery of products by courier to a customer's home.

A mail order transaction with delivery and pickup of the ordered food products in a convenient and 24/7 available self-service device requires thermal conditions that eliminate unacceptable bacterial changes in products to maintain their desired sensory and nutritional quality as well as safety for human health. While maintaining packaging separation, food products of different types require specific storage temperatures, and in the period until the customer collects them, these temperatures should be approximately: for fresh vegetables, fruit, milk, eggs and cold meats: +1° C. to +8° C.; +4° C. on average; for frozen meat, poultry, fish and vegetables: −15° C. to −25° C.; −18° C. on average.

Multi-locker cooling and freezing devices are known in which food products ordered online are delivered and placed by courier into lockers assigned to the order by software and in which there is a storage temperature required for a given product or set of products. Once the customer receives an electronic message that the order is complete and the products have been delivered to the selected device, as well as an access code to the locker, the customer collects the ordered products from “their” locker, accessible from the front wall of the device housing. One of such devices, described in the patent document no. EP3336459B1, has lockers individually supplied with liquid refrigerant via heat distribution valves from a central cooling system, with the possibility of setting the cooling temperature in the range from 4° C. to 21° C. or a freezing temperature in the range from −16° C. to −20° C. in individual lockers or in a group of lockers. The device operates on similar principles to automated postal item collection points, except that each locker has its own dedicated cooling system to maintain the temperature required for the product stored inside it. This device, like the one described in the patent document no. EP1977176B1, may have lockers inside a space closed with an external door. The possibility of selecting the optimal storage temperature for specific food products makes the device's structure complex and increases the probability of failure.

Development works carried out to improve the logistic efficiency of e-sales in the retail market and to achieve the goal of “ordering and collecting products on the same day”, which is very important to the customer, included solutions that supported storage operations with the use of an industrial robot which can operate lockers at heights inaccessible for customers of average height. On the front wall of the device housing, instead of a door to many lockers, there is at least one sending and collecting window for transportation baskets stored by a manipulator on racks. In a state-of-the-art solution, in the patent document no. US20150291357A1, a description is given of a robotic device to pick up perishable food products ordered online. Inside the housing, the device has thermally separated chambers in which different temperatures are maintained. According to the description of the invention's exemplary embodiment, there are two cooling chambers in which the temperature ranges from +1° C. to +5° C. and from +5° C. to +12° C. as well as one freezing chamber with a temperature range between −18° C. and −35° C. In the chambers, there are racks with storage slots for vertically arranged transportation baskets in which the ordered products are stored. The racks are connected by support columns in a parallel arrangement. A Cartesian manipulator is built in between the racks, consisting of a horizontal rail mounted above the cooling and freezing chambers and a trolley driven along the rail, having a vertically driven platform with transportation basket support plates extending in both perpendicular directions. The chambers are covered from above with thermal insulating covers which are opened by a pin mounted on the bottom surface of the trolley platform. To open the cover, the pin is inserted by means of a manipulator into the opening of the folding lid. On the front wall of the device housing there is a sending and collecting window into which the courier inserts the transportation baskets with the ordered products properly arranged according to the required temperature, which are then picked up and moved on the manipulator platform to the storage chambers and slots indicated by the software. The customer, after receiving information that the delivery is complete and logging into the device via the access code received, activates the manipulator which collects the baskets with the ordered products on the platform and delivers them to the window, enabling them to be picked up from “their” transportation baskets.

The solution with chamber covers, which are usually removed each time from different chambers, significantly slows down customer service, and the combination of the manipulator's operating space with the environment in relatively long periods when the chambers are opened reduces thermal efficiency. Additionally, sending and collecting windows that are open from the outside require continuous supervision due to the possibility of access to the device's internal space by persons with bad intentions, who can damage the device.

In other state-of-the-art solutions—for example, in the patent documents nos. PL224806B2, FR2549942A1, DE1057147B—descriptions are given of multi-locker cooling devices for storing and picking up products purchased online, in which on the side wall of the cooling module housing, above the highest lockers with perforated walls, there is a refrigeration unit which, by means of a fan, initiates a vertical flow of cooled air through the permeable lockers with food products. From the bottom zone, the air is drawn in through a return duct to the evaporator of the refrigeration unit.

The present disclosure solves the technical problem of developing a simple automated storage and pickup device for food products purchased by mail order through online transactions, wherein an industrial robot and racks of increased height are used for storage operations. An effective cooling system for food products is to be achieved by introducing two temperature ranges in two adjacent modules with a volumetrically, significantly larger cooling module. At the same time, the modules are programmatically integrated by a common courier/customer interface, in a device with high thermal efficiency and customer self-service without the need for constant supervision by a service technician.

### SUMMARY

The present invention has many features in common with the known state-of-the-art solutions presented above; it comprises programmatically integrated cooling and freezing modules and a Cartesian manipulator embedded between the racks of the freezing module. It is distinguished by the fact that the sending and collecting windows in the cooling module have a sluice design with sluice recesses fixed from the inside to the front wall of the cooling module and below the storage slots. In the periods when the sending and collecting window is in contact with the environment, the rear opening of the sluice recess is closed with a movable rear partition. In addition, in this window there is a drawer closed at the front by a single-leaf door with a vertical hinge mounted to the front framing of the drawer. On the opposite side, the door is connected to the framing by an electromagnetic lock. The slidable drawer is moved in the sluice recess via a bottom-mounted ejection drive. When the drawer is ejected to the open position, the products in the transportation basket are accessible from above. In this position, the transportation basket is blocked by locking devices on the opposite side walls of the drawer and the sluice recess. The lockers in the freezing module have walls perforated with holes and the number of the currently available locker with the ordered frozen food is illuminated on the locker door.

In the preferable embodiment of the invention, the cooling module in the front and rear racks comprises at least two adjacent transverse sections, each with two vertical support columns of storage slots, and a built-in sending and collecting window at the bottom, symmetrically between the support columns, as well as an interface with a touch screen, QR and/or RFID barcode reader located above, symmetrically between the windows.

Preferably, the transportation basket between the upper edges of the side walls defining its width has support bars that project outwards and have dog teeth at the ends.

The embodiment preferably has centring rails fixed on the drawer side walls and a stop rail on the inner surface of the door, which together determine the position of the transportation basket in the drawer. It is advisable for the embodiment if, when the drawer is ejected, the locking devices of the transportation basket have upper lever clamps mounted on bearings in the rear upper corners of the drawer side walls and controlled by cams fixed to the sluice recess side walls.

If the drawer bottom is fitted with transportation basket support bars and built-in strain gauges to measure the weight of a basket loaded with ordered products, it is possible to additionally check whether the permissible weight of the parcel has been exceeded or whether the customer has left any object inside the basket.

Preferably, the ejection drive is located under the drawer bottom and consists of a two-way gearmotor and tooth gears.

It is possible to check whether an item protrudes beyond the basket by incorporating a retro-reflective photoelectric sensor into the side walls at the door and at the height of the upper edge of the transportation basket.

The movable partition of the sluice recess rear opening preferably is a louvre curtain made of slats articulated along the edges. The curtain is moved by a drive unit in lateral vertical guides fixed along the edge of the sluice recess rear opening. In this embodiment of the present invention, the slats have a circle arc profile and the drive unit is fixed at the upper edge of the sluice recess rear opening and has a gearmotor and a shaft with flexible rollers of a radius equal to the arc of the slat circle. With these rollers, the shaft winds the rear partition from vertical guides to horizontal guides under the upper wall of the sluice recess.

Preferably, the Cartesian frame manipulator used in the device has a trolley with a C-shaped frame rotated 90° upwards by its web and the manipulator's vertical arms guide the manipulator on rollers in its inner frame which is horizontally moved by a toothed belt in an outer frame. In this embodiment, the gripping mechanism has two side arms positioned parallel to the vertical arms of the trolley frame and which have the transportation basket dog at the end. The side arms are attached to the extension shaft mounted on bearings under the web of the trolley frame and driven by a two-way gearmotor.

As an option, it is recommended to use one of the following three gripping mechanism solutions in the device.

In the first one, the side arms consist of a longer element and a shorter element connected by a swing joint. The upper end of the longer element is fixed to the extension shaft, and the shorter element has a dog swing pin at the end. Both elements have chain transmissions coupled with a planetary gear in the swing joint.

In the second embodiment, the gripping mechanism has side arms formed by a deltoid system of longer and shorter lever arms, symmetrical to the plane defined by the axes of both vertical arms of the trolley frame. In the middle position, the system has its longer arms attached with their upper ends to two extension shafts mounted on bearings in parallel under the trolley frame web and driven in opposite directions by a tooth gear of the two-way gearmotor. The lower ends of the longer arms are connected by a tooth gear in a lower cramp with the shorter arms directed upwards. At the upper ends, the shorter arms are mounted on bearings in the dog support which is additionally connected with the lower cramp by a control arm.

The gripping mechanism according to the third embodiment has side arms formed by telescopic, double-sided booms with a rack and pinion drive. It consists of:
a base element with brackets protruding symmetrically and horizontally in both directions, rigidly connected with the vertical arm of the trolley frame and extending relative to each other on ball circulation guides, and
a central element driven form the side of the base element by a toothed gear whose gear rack is fixed along the central element and connected with two gears mounted on bearings on shafts symmetrically spaced at both ends of the base element, and
a dog element driven by a flexible connection drive from the side of the central element, and whose steel cord is wound around two rollers mounted on bearings on the ends of the central element; the steel cord ends are fastened in hooks at both ends of the dog element. Gear shafts of the toothed gear are driven by a transmission with a toothed belt which is wound around a toothed drive wheel mounted at the top on the extension shaft, and below, around two toothed directional wheels mounted on bearings symmetrically with respect to the plane of the axes of both vertical arms of the trolley frame, and around two horizontally spaced toothed reversing wheels mounted on the gear shafts.

Preferably, the air circuit in the cooling module is supplied by two evaporators installed in parallel next to each other on the side wall of the refrigeration unit, the fans of which are connected to the air blow ducts routed above and along the axis of the front and rear racks, and whose bottoms are perforated with holes of diameters increasing with the distance from the fan.

The device according to the invention is distinguished mainly by the design of the sending and collecting window, which creates different access conditions to the drawer space:
the courier, after releasing the lock with an access code and opening the door, is able to insert a transportation basket with ordered products, remove a basket not picked up by the customer from the drawer, or remove an empty basket, and
the customer, after entering the image or digital code received via SMS into the interface and the automatic drawer ejection with the door closed, gains access to it from above and is able to pick up their ordered products from the basket immobilised with locking devices in the drawer. In addition, when the drawer is ejected, the rear partition is closed, which ensures that the internal space of the cooling module is separated; this eliminates the unfavourable heat exchange with the environment, and prevents the introduction of objects that can damage the manipulator. The device design, i.e. adjusting the number of sluices to the number of customers for a given location, allows to shorten the waiting time in periods when the number of customers picking up ordered parcels is increased.

### DRAWINGS

The present invention is explained with a description of the exemplary prototype embodiment shown in the drawing, whose individual figures are as follows:

FIG. 1—perspective front view of the device,

FIG. 2—vertical section through the cooling module according to line A-A,

FIG. 3—perspective top view of the cooling module with the roof removed,

FIG. 4—top view of the transportation basket,

FIG. 5—support column with storage slots,

FIG. 6—inside view of the front rack with sending and collecting window,

FIG. 7—perspective view of the racking structure with manipulator arms and air blow ducts,

FIG. 8—front view of the sending and collecting window with the door open,

FIG. 9—side view of the vertical section through the sending and collecting window with the door closed,

FIG. 10—side view of the vertical section through the sending and collecting window with the drawer open,

FIG. 11—perspective top view of the sending and collecting window with the drawer open,

FIG. 12—Cartesian manipulator,

FIG. 13—perspective view of the trolley with the transportation basket caught in the chain gripping mechanism when travelling between the racks,

FIG. 14—perspective view of the trolley with the chain gripping mechanism with elements closed,

FIG. 15—view of the chain gripping mechanism with the arms extended forward,

FIG. 16—cross-section through the open elements of the chain gripping mechanism,

FIG. 17—perspective view of the trolley with the deltoid gripping mechanism with arms closed,

FIG. 18—view of the deltoid gripping mechanism with arms extended forward,

FIG. 19—perspective view of the trolley with the telescopic gripping mechanism with elements slid together,

FIG. 20—perspective view of the trolley with the telescopic gripping mechanism with elements extended forward,

FIG. 21—vertical section through the drive of elements of the telescopic gripping mechanism with elements extended forward,

FIG. 22—front view of the freezing cabinet in the freezing module,

FIG. 23—perspective view of the rack with permeable lockers,

FIG. 24—view of the locker door with the cut-out number

FIG. 25—cross-section of the door

### DESCRIPTION

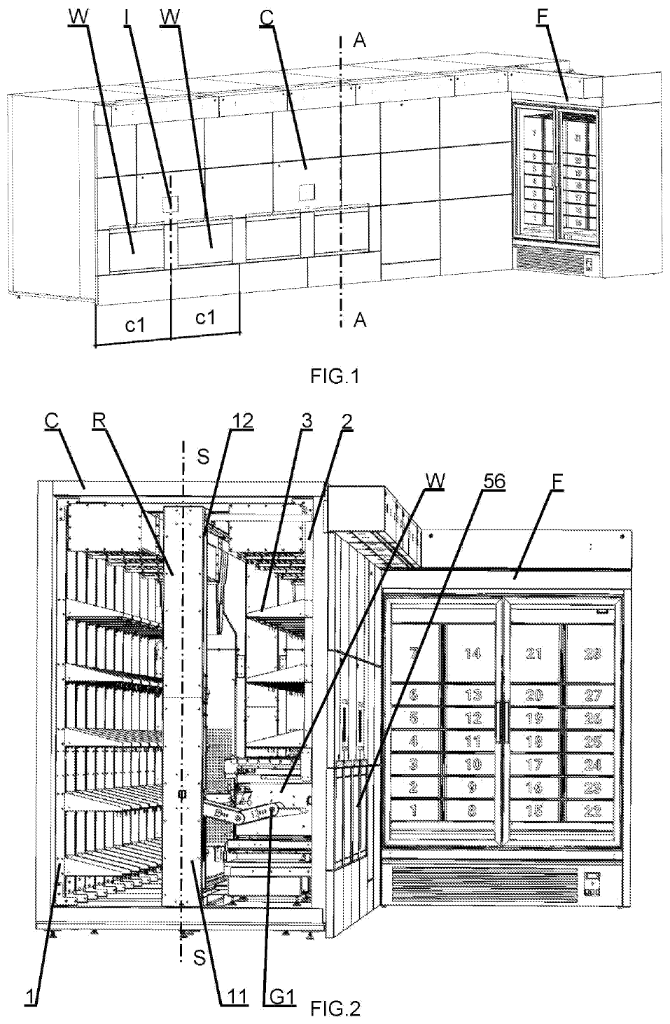

The devices, according to the invention shown in FIG. 1, can be installed in supermarkets, general stores and places of everyday human presence: in housing estates, office building zones, car parks, gas stations and similar places. The device comprises two modules: a cooling module C and a freezing module F, whose operation is integrated by software for the management of mail order transactions and which, in terms of device control, records the location of transportation baskets in the device's storage slots and keeps a real-time inventory of their occupancy.

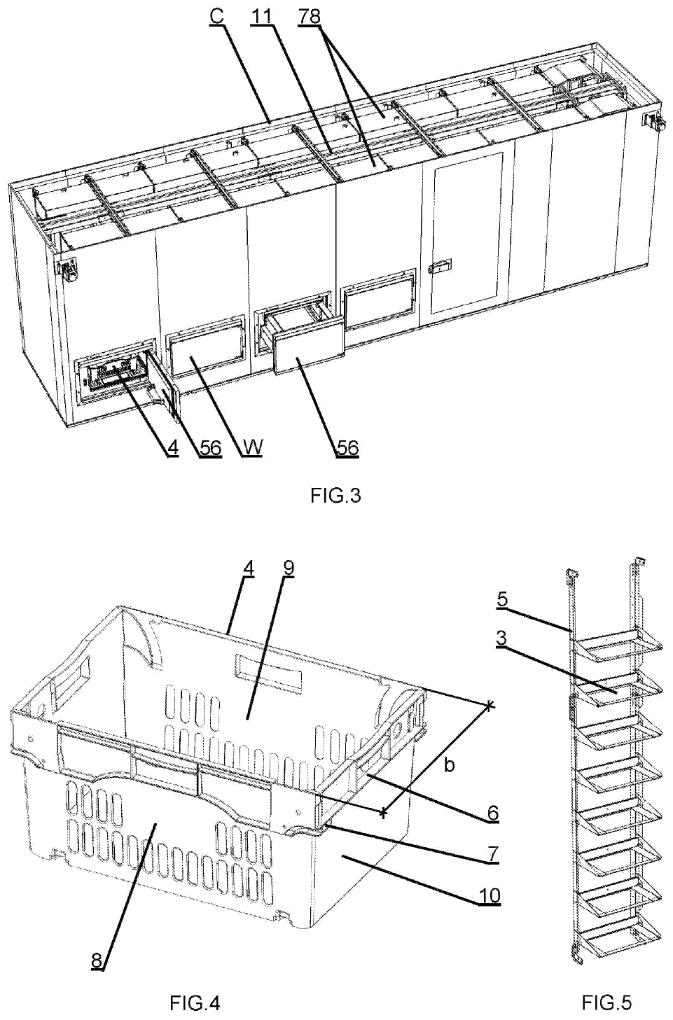

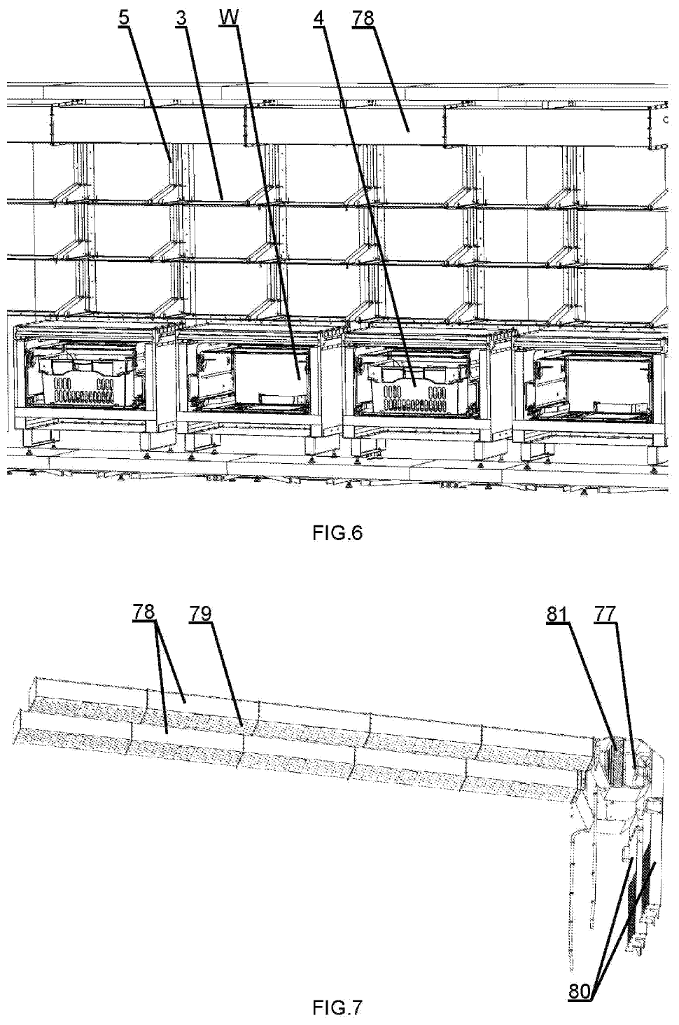

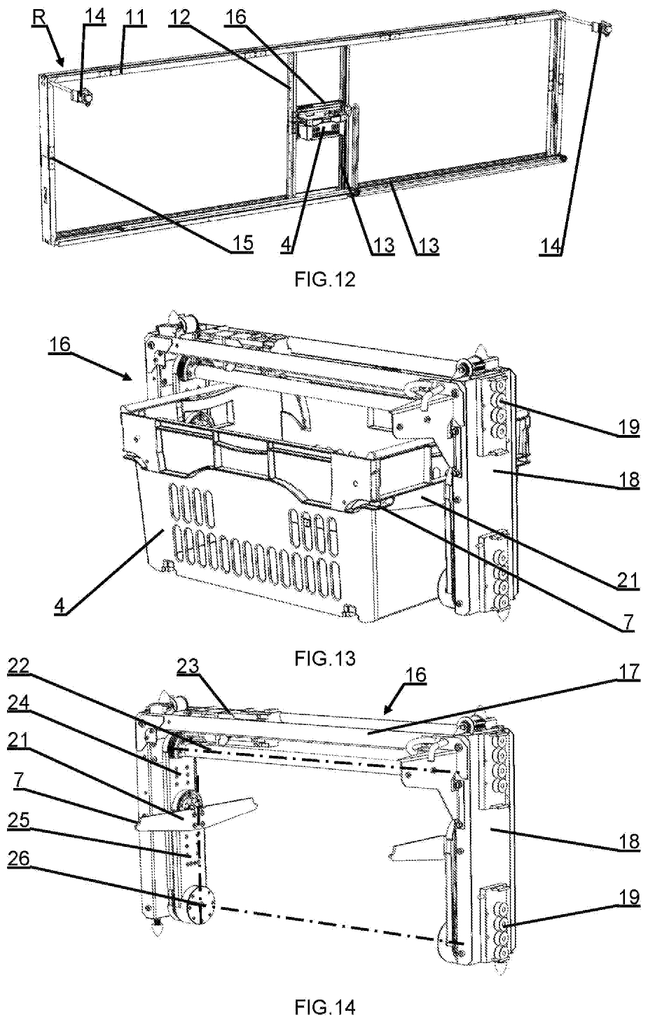

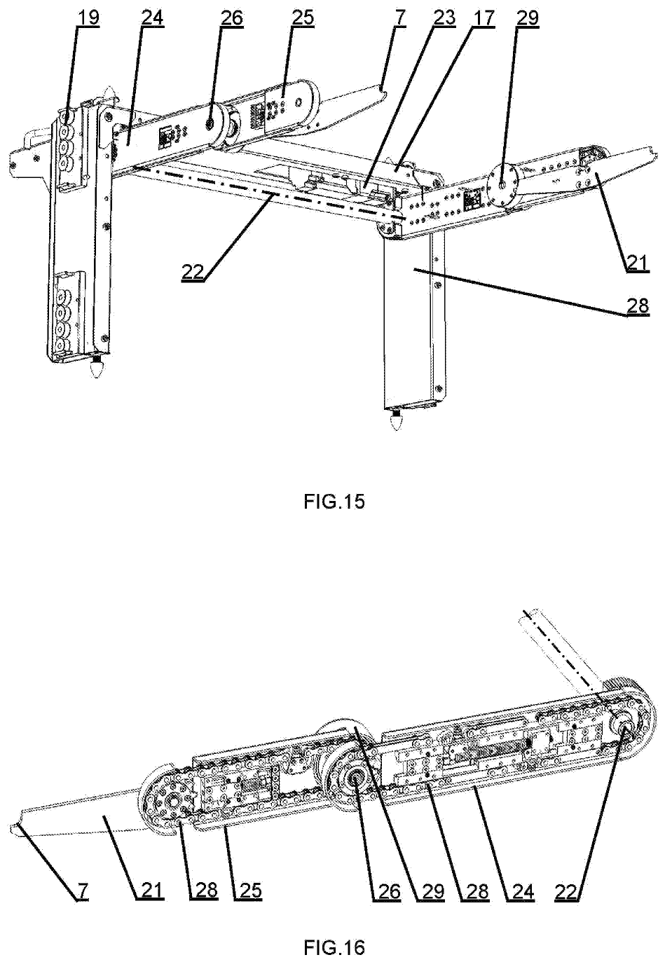

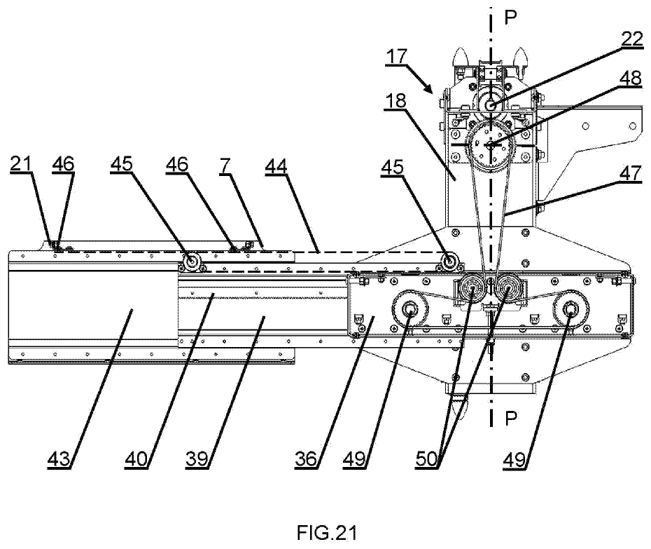

The cooling module C, in the form of a rectangular cuboid with walls made of boards thermally insulated with polyurethane foam, has the following approximate dimensions: length—750 cm to 950 cm, height—240 cm to 350 cm, and depth—approximately 160 cm. The length of the cooling module C depends on the number of sections c1 used, each of which contains two vertical support columns 5 for storage slots 3 (FIGS. 2, 3 and 5), a built-in sending and collecting window W at the bottom, symmetrically between the support columns 5, and an interface I operating in courier and customer modes, located above, symmetrically between the adjacent windows W. The interface I has a touch screen and a QR and RFID barcode reader. The cooling module C in FIG. 1 comprises four sections c1, is 950 cm long and has a total of 200 storage slots 3. Inside the housing of the cooling module C there are front 2 and rear 1 racks with cantilever storage slots 3 for transportation baskets 4 whose walls 8, 9, 10 are perforated with holes (FIG. 4). The front 2 and rear 1 racks are rigidly connected with support columns 5 (FIG. 6, 7), in an arrangement parallel to the front wall and with spacing B=60 cm (FIG. 2) as well as a transportation basket 4 width of b=40 cm. In this embodiment, the transportation basket 4, with overall dimensions of 60 cm×40 cm×30 cm, under the upper edges of the side walls 10 define its width b, has support bars 6 that project outwards and have dog teeth 7 (FIG. 4) at the ends. In the vertical plane of symmetry S-S between the front 2 and rear 1 racks, there is an electrically driven Cartesian frame manipulator R. The manipulator R has a fixed outer frame 11 and an inner frame 12 which moves horizontally in the outer frame 11 (FIG. 12). In the inner frame 12, a trolley 16 with a gripping mechanism G is vertically guided (FIGS. 13 to 21). The inner frame 12 and the trolley 16 move in an “H” configuration, are driven through two toothed belts 13 by electric motors 14 mounted in the corners of the outer frame 11 (FIG. 12). The gripping mechanism G has forward and backward extending side arms 20 with the dogs 21 of the transportation basket 4 at their ends. The Cartesian manipulator R moves transportation baskets 4 according to software-controlled operations: for the courier—between the sending window W and the storage slot 3 indicated by the software in the front 2 or rear 1 rack; and for the customer—in the opposite direction, i.e. from the slot 3 with “their” transportation basket 4 to the collecting window W.

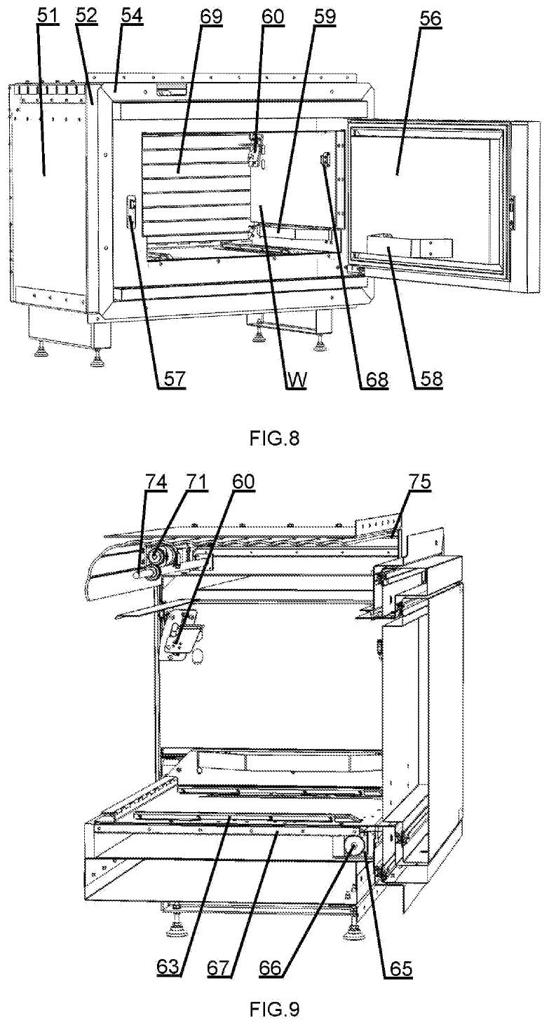

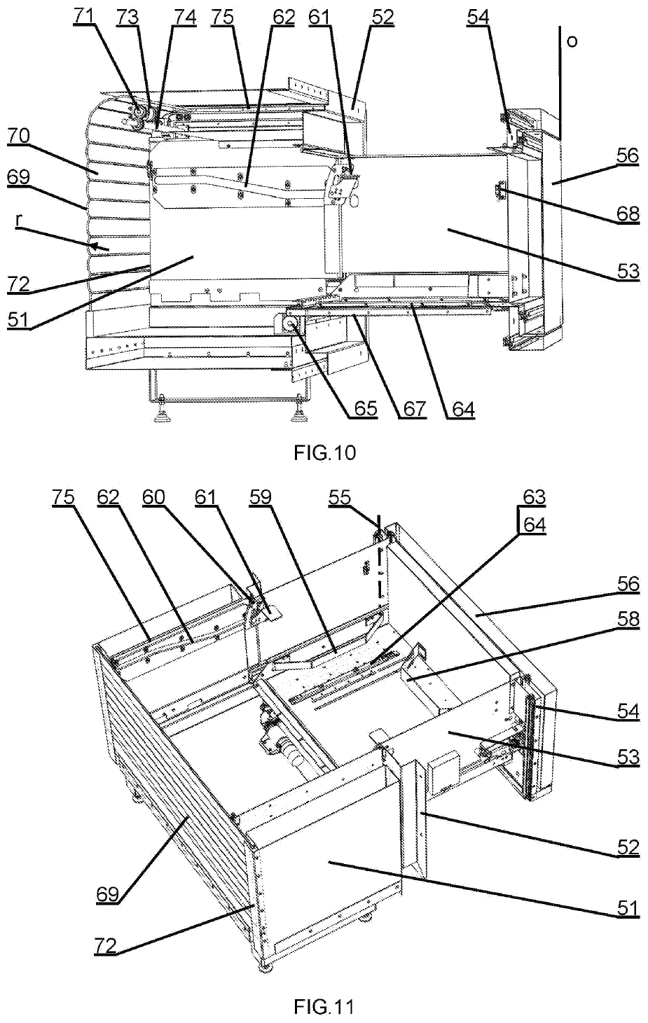

The sending and collecting windows W in the cooling module C (FIGS. 8 to 11) have a sluice design with sluice recesses 51 fixed from the inside to the front wall of the cooling module C, below the storage slots 3. In the periods when the sending and collecting window W is in contact with the environment, the rear opening of the sluice recess 51 is closed with a movable rear partition 69. In the sluice recess 51, there is a drawer 53 closed at the front by a single-leaf door 56 with a vertical hinge 55 mounted to the front framing 54 of the drawer 53. On the opposite side, the door 56 is connected to the framing 54 by an electromagnetic lock 57. The slidable drawer 53 is moved in the sluice recess 51 via a bottom-mounted ejection drive 65 to the open position o, and the products in the transportation basket 4 are accessible from above. The ejection drive 65 comprises a gearmotor 66 and tooth gears 67. On the drawer 53 side walls, there are centring rails 59 and, on the inner surface of the door 56, there is a stop rail 58, which together determine the position of the transportation basket 4 in the drawer 53. When the drawer 53 is ejected to the open position o, the transportation basket 4 is blocked by locking devices 60 on the opposite side walls of the drawer 53 and the sluice recess 51. Locking devices 60 have upper lever clamps 61 mounted on bearings in the rear upper corners of the drawer 53 side walls and controlled by cams 62 fixed to the sluice recess 51 side walls. The transportation basket 4 rests in the drawer 53 on support bars 63 with built-in load strain gauges 64; a retro-reflective photoelectric sensor 68 is installed in the side walls of the drawer 53, at the door 56 and at the height of the upper edge of the transportation basket 4. The movable rear partition 69, which periodically closes the rear opening of the sluice recess 51, is a louvre curtain with slats 70 articulated along the edges. Slats 70 have a circle arc profile r, and the drive unit 71 is fixed at the upper edge of the sluice recess 51 rear opening and has a gearmotor 73 and a shaft 74 with flexible rollers of a radius r equal to the slat 70. Under pressure from the rollers, the rear partition 69 is moved in the side vertical guides 72 along the edge of the sluice recesses 51 rear opening and in the horizontal guides 75 under the upper wall of the sluice recess 51.

A trolley 16 in the Cartesian frame manipulator R has a C-shaped trolley frame 17 rotated 90° upwards by its web, and vertical arms 18 guide the manipulator R on rollers 19 in its inner frame 12 which is horizontally moved by a toothed belt 13 in the outer frame 11 (FIG. 12-11). The gripping mechanism G has two side arms 20 positioned parallel to the vertical arms 18 of the trolley frame 17 and which have dogs 21 of the transportation basket 4 at their ends. The side arms 20 are attached to the extension shaft 22 mounted on bearings under the web of the trolley frame 17 and driven by a two-way gearmotor 23 (FIG. 14).

The device offers three embodiments of the gripping mechanism. In the first gripping mechanism G1 (FIGS. 13 to 16), the side arms 20 consist of a longer element 24 and a shorter element 25 connected by a swing joint 26. The upper end of the longer element 24 is fixed to the extension shaft 22, and the shorter element 25 has a dog 21 swing pin 27 at the end. Both elements 24 and 25 have chain transmissions 28 coupled with a planetary gear 29 in the swing joint 26.

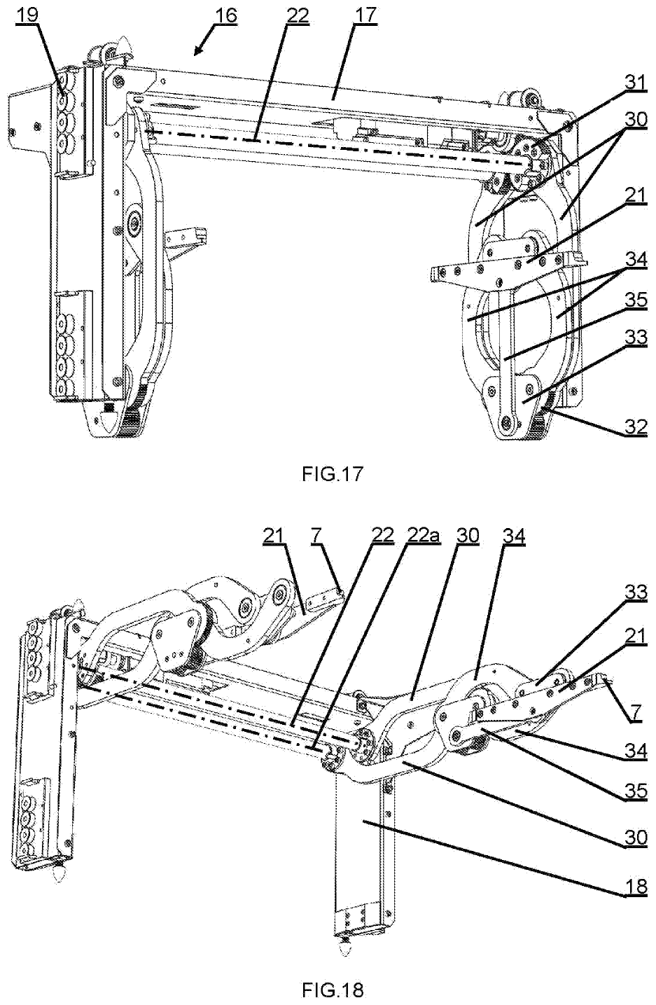

In the second embodiment, the gripping mechanism G2 (FIGS. 17 to 18) has side arms 20 formed by a deltoid system of longer 30 and shorter 34 lever arms, symmetrical to the plane P-P defined by the axes of both vertical arms 18 of the trolley frame 17. In the middle position, the longer arms 30 are attached with their upper ends to two extension shafts 22 and 22a mounted on bearings in parallel under the trolley frame 17 web and driven in opposite directions by a tooth gear 31 of the two-way gearmotor 23. The lower ends of the longer arms 30 are connected by a tooth gear 32 in a lower cramp 33 with the shorter arms 34 directed upwards. Their upper ends are mounted on bearings in the dog 21 support, which is additionally connected with the lower cramp 33 by a control arm 35.

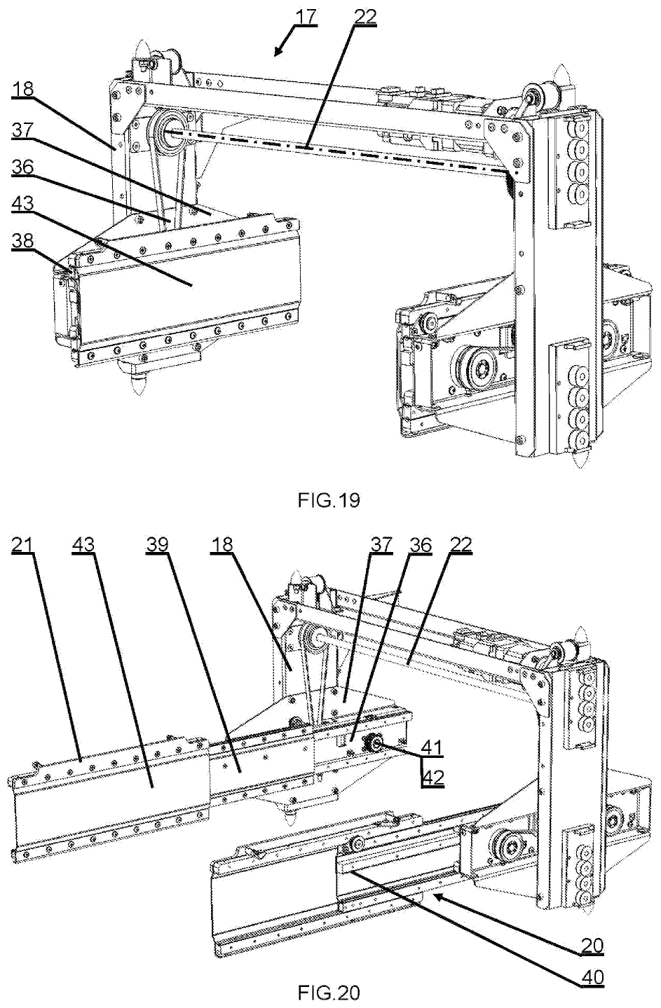

Another, third embodiment of the gripping mechanism G3 (FIGS. 19 to 21) has side arms 20 formed by telescopic, double-sided booms with a rack and pinion drive. It is made up of three elements: a base element 36, a central element 39, and a dog element 43, which are slideably connected to each other on ball circulation guides 38. The base element 36 is rigidly connected with a vertical arm 18 of the trolley frame 17 and has brackets 37 protruding symmetrically and horizontally in both directions. The central element 39 is driven form the side of the base element 36 by a toothed gear 40, 41 whose gear rack 40 is fixed along the central element 39 and connected with two gears 41 mounted on bearings on shafts 42 symmetrically spaced at both ends of the base element 36. The dog element 43 is driven by a flexible connection drive 44, 45, 46 from the side of the central element 39, whose steel cord 44 is wound around two rollers 45 mounted on bearings on the ends of the central element 39, and the steel cord 44 ends are fastened in hooks 46 at both ends of the dog element 43. Gear 41 shafts 42 of the toothed gear 40, 41 are driven by a transmission with a toothed belt 47 which is wound around a toothed drive wheel 48 mounted on the top and connected with the extension shaft 22. Below, the toothed belt 47 is wound around two toothed directional wheels 49 mounted on bearings symmetrically with respect to the plane P-P and around two horizontally spaced toothed reversing wheels 50 mounted on the gear 41 shafts 42.

The internal space of the cooling module C is circulated with cooling air P at a stabilised temperature in the range of 1° C.-8° C., optimally 4° C. (FIG. 2, 3, 7). The cooling air circuit P is initiated by a refrigeration unit 76 mounted on the side wall of the cooling module C housing and its high-performance fans 77 are connected to air blow ducts 78 routed in the ceiling zone above the rear 1 and front 2 racks. The bottoms of the air blow ducts 78 are perforated with holes of diameters increasing with the distance from the fan. The cool air flows down the transportation baskets 4 to the bottom zone from where it is drawn in through a duct 80 mounted on the side wall, and returns upwards to the inlet of the refrigeration unit 76 evaporator 81. Evaporators 81 operate with R744 refrigerant, and the condensate is drained through pipes under the body of the cooling module C.

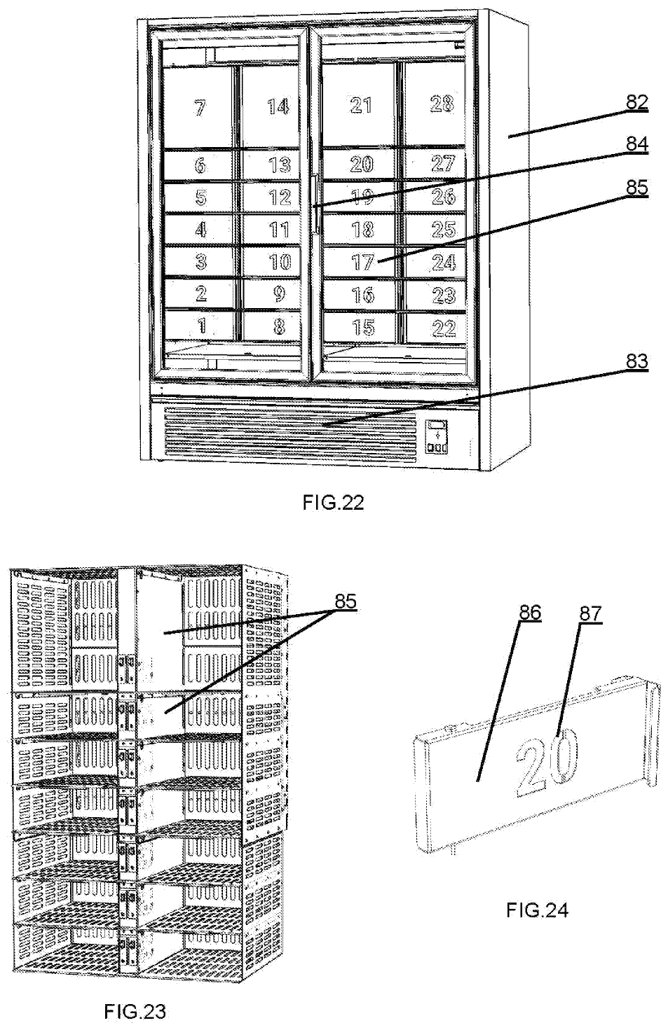

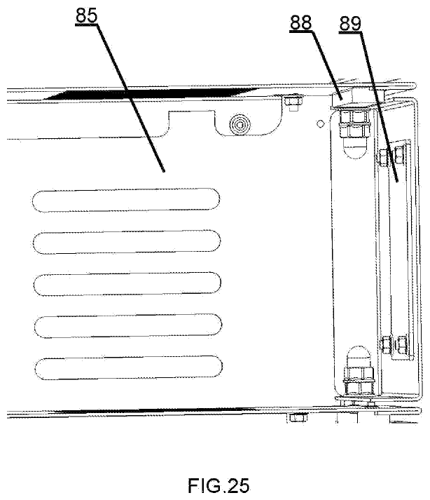

The freezing module F (FIGS. 22 to 25) has a commercially available freezing cabinet 82 whose base is approximately 170 cm×80 cm, with a height of 200 cm, with a compression-type freezing system 83 that freezes the air to temperatures in the range from −18° C. to −22° C. as well as with double-leaf glazed doors 84. Inside the device, there is a rack with a total of 28 lockers 85, including four upper lockers with increased volume, equipped with electromagnetic locks controlled by an integrated interface I. Lockers 85 have perforated walls and their doors 86 have cut-out numbers 87 covered at the back by a polycarbonate plate 89 which diffuses the light of a LED 88 mounted under the upper shelf, which is activated by a signal emitted by the program informing that the ordered products are ready for pickup.

### LIST OF SYMBOLS IN THE DRAWING

C. Cooling module
   1. rear rack
   2. front rack
   3. storage slot
   4. transportation basket
   5. support column
   6. support bar
   7. dog tooth
   8. front wall
   9. rear wall
   10. side wall
R. Cartesian manipulator
   11. outer frame
   12. inner frame
   13. toothed belt
   14. electric motor
   15. belt tensioner
   16. trolley
   17. trolley frame
   18. vertical arm
   19. rollers
   20. side arms
   21. dog
   22. extension shaft
   23. gearmotor
G1. Chain gripping mechanism
   24. longer element
   25. shorter element
   26. swing joint
   27. swing pin
   28. chain transmission
   29. planetary gear
G2. Deltoid gripping mechanism
   30. longer arm
   31. extension tooth gear
   22a. extension shaft (second)
   32. lower cramp tooth gear
   33. lower cramp
   34. shorter arm
   35. control arm
G3. Telescopic gripping mechanism
   36. base element
   37. bracket
   38. ball circulation guide
   39. central element
   40. gear rack
   41. gear
   42. shaft
   43. dog element
   44. cord
   45. roller
   46. hook
   47. toothed belt
   48. drive wheel
   49. directional wheel
   50. reversing wheel
W. Sending and collecting window
   51. sluice recess
   52. sluice frame
   53. drawer
   54. framing
   55. hinge
   56. door
   57. door lock
   58. stop rail
   59. centring rail
   60. basket locking device
   61. upper clamp
   62. cam
   63. support bar
   64. load strain gauge
   65. drawer ejection drive
   66. gearmotor
   67. tooth gear
   68. photoelectric sensor
   69. rear partition
   70. slat
   71. drive unit
   72. vertical guide
   73. gearmotor
   74. shaft
   75. horizontal guide
P. Cooling air circuit
   76. refrigeration unit
   77. fan
   78. air blow duct
   79. perforated bottom
   80. return duct
   81. evaporator
F. Freezing module
   82. freezing cabinet
   83. freezing system
   84. glazed doors
   85. locker
   86. door
   87. cut-out number
   88. LED
   89. polycarbonate plate
I. interface
S-S. plane of symmetry between the racks
P-P. plane of axis of the trolley frame vertical arms
B. rack spacing
b. transportation basket width
c1. cooling module section
r. radius of the rear partition slat arc
o. drawer open position

What is claimed:

1. An automated storage and pickup device for food products purchased by mail order via the internet, comprising a programmatically integrated cooling module (C) and freezing module (F), and of which
the cooling module (C), in a rectangular cuboid, thermally insulated housing, further comprises front (2) and rear (1) racks with cantilever storage slots (3) for transportation baskets (4) with perforated walls, and these racks (1, 2) are rigidly connected with support columns (5) in a parallel arrangement with spacing (B) greater than the width of the transportation basket (4); and which further comprises
an electrically driven Cartesian frame manipulator (R) in the vertical plane of symmetry (S-S) between the front (2) and rear (1) racks, with a fixed outer frame (11) and an inner frame (12) which moves horizontally in the outer frame (11), a trolley (16) with a vertically guided gripping mechanism (G1, G2, G3) whose side arms (20) extend forwards and backwards and have dogs (21) of the transportation basket (4) at their ends, and the Cartesian manipulator (R) moves transportation baskets (4) according to the software-controlled operations between the sending and collecting window (W) and the designated storage slot (3) in the front (2) and rear (1) racks; and in which
the internal space of the cooling module (C) is circulated with cooling air (P) at a stabilised temperature in the range between 1° C. and 8° C. (optimally 4° C.), produced by a refrigeration unit (76) mounted on the side wall of the cooling module (C) housing and whose fans (77) blow air into the ceiling zone above the racks (1, 2), and the air flows further down the transportation baskets (4) to the bottom zone from where it is drawn in through a duct (80) mounted on the side wall, and returns upwards to the inlet of the refrigeration unit (76) evaporator (81); on the other hand
the freezing module (F) comprises a freezing cabinet (82) with a compression-type freezing system (83) that freezes the air to temperatures in the range from −18° C. to −22° C.; it also has double-leaf glazed doors (84), and an embedded rack of lockers (85) with electromagnetic locks controlled by the integrated interface (I);
characterised in that
the sending and collecting windows (W) in the cooling module (C) have a design of sluices comprising:
a sluice recess (51) fixed from the inside to the front wall of the cooling module (C), below the storage slots (3), and whose rear opening is closed with a movable rear partition (69) in the periods when the sending and collecting window (W) is in contact with the environment,
a drawer (53) closed at the front by a single-leaf door (56) with a vertical hinge (55) mounted to the front framing (54) of the drawer (53), and, on the opposite side, the door (56) is connected to the framing (54) by an electromagnetic lock (57), and the slidable drawer (53) is moved in the sluice recess (51) via
a bottom-mounted ejection drive (65) to the open position (o), and the products in the transportation basket (4) are accessible from above, whereby
when the drawer (53) is ejected to the open position (o), the transportation basket (4) is blocked by locking devices (60) on the opposite side walls of the drawer (53) and the sluice recess (51),
in the freezing module (F), lockers (85) have walls perforated with holes and the number (87) of the order currently available for pickup is illuminated on the door (86).

2. The device of claim 1, wherein the cooling module (C) in the front (2) and rear (1) racks comprises at least two adjacent transverse sections (s1), each with two vertical support columns (5) of storage slots (3), and a built-in sending and collecting window (W) at the bottom, symmetrically between the support columns (5), as well as an interface (I) with a touch screen, QR and/or RFID barcode reader located above, symmetrically between the windows (W).

3. The device of claim 1, wherein the transportation basket (4) under the upper edges of the side walls (10) define its width (b), has support bars (6) that project outwards and have dog teeth (7) at the ends.

4. The device of claim 1, wherein on the drawer (53) side walls, there are centring rails (59) and, on the inner surface of the door (56), there is a stop rail (58), which together determine the position of the transportation basket (4) in the drawer (53).

5. The device of claim 1, wherein the locking devices (60) of the transportation basket (4) have upper lever clamps (61) mounted on bearings in the rear upper corners of the drawer (53) side walls when the drawer (53) is ejected to the open position (o), and which are controlled by cams (62) fixed to the sluice recess (51) side walls.

6. The device of claim 4, wherein at the bottom of the drawer (53), there are support bars (63) of the transportation basket (4) with built-in load strain gauges (64).

7. The device of claim 1, wherein the ejection drive (65) is installed under the bottom of the drawer (53) and comprises a gearmotor (66) and tooth gears (67).

8. The device of claim 1, wherein a retro-reflective photoelectric sensor (68) is installed in the side walls of the drawer (53), at the door (56) and at the height of the upper edge of the transportation basket (4).

9. The device of claim 1, wherein the movable rear partition (69) of the sluice recess (51) rear opening is a louvre curtain with slats (70) articulated along the edges, and which is moved by a drive unit (71) in lateral vertical guides (72) fixed along the edge of the sluice recess (51) rear opening.

10. The device of claim 9, wherein the louvre rear partition (69) has slats (70) with a circle arc profile (r), and the drive unit (71) is fixed at the upper edge of the sluice recess (51) rear opening and has a gearmotor (73) and a shaft (74) with flexible rollers of a radius equal to the arc (r) of the slat (70) circle, and with these rollers, the shaft (74) winds the rear partition (69) from vertical guides (72) to horizontal guides (75) under the upper wall of the sluice recess (51).

11. The device of claim 1, wherein the trolley (16) of the Cartesian manipulator (R) has a C-shaped trolley frame (17) rotated 90° upwards by its web, and vertical arms (18) guide the manipulator (R) on rollers (19) in its inner frame (12) which is horizontally moved by a toothed belt (13) in the outer frame (11), whereby the gripping mechanism (G1, G2, G3) has two side arms (20) positioned parallel to the vertical arms (18) of the trolley frame (17) and which have dogs (21) of the transportation basket (4) at their ends and are attached to the extension shaft (22) mounted on bearings under the web of the trolley frame (17) and driven by a two-way gearmotor (23).

12. The device of claim 11, wherein the gripping mechanism (G1) has side arms (20) comprising a longer element (24) and a shorter element (25) connected by a swing joint (26), and the upper end of the longer element (24) is fixed to the extension shaft (22), and the shorter element (25) has a dog (26) swing pin (27) at the end, whereby both elements (24, 25) have chain transmissions (28) coupled with a planetary gear (29) in the swing joint (26).

13. The device of claim 11, wherein the gripping mechanism (G2) has side arms (20) formed by a deltoid system of longer (30) and shorter (34) lever arms, symmetrical to the plane (P-P) defined by the axes of both vertical arms (18) of the trolley frame (17); in the middle position, the side arms (20) have:
(17) longer arms (30) attached with their upper ends to two extension shafts (22, 22a) mounted on bearings in parallel under the trolley frame (17) web and driven in opposite directions by a tooth gear (31) of the two-way gearmotor (23), and with their lower ends connected by a tooth gear (32) mounted on bearings in a lower cramp (33) with:
the shorter arms (34) directed upwards, whose upper ends are mounted on bearings in the dog (21) support which is additionally connected with the lower cramp (33) by a control arm (35).

14. The device of claim 11, wherein the gripping mechanism (G3) has side arms (20) formed by telescopic, double-sided booms with a rack and pinion drive, which comprise:
a base element (36) with brackets (37) protruding symmetrically and horizontally in both directions, rigidly connected with a vertical arm (18) of the trolley frame (17) and extending relative to each other on ball circulation guides (38), and
a central element (39) driven form the side of the base element (36) by a toothed gear (40, 41) whose gear rack (40) is fixed along the central element (39) and connected with two gears (41) mounted on bearings on shafts (42) symmetrically spaced at both ends of the base element (36), and
a dog element (43) driven by a flexible connection drive (44, 45, 46) from the side of the central element (39), and whose steel cord (44) is wound around two rollers (45) mounted on bearings on the ends of the central element (39), and the steel cord (44) ends are fastened in hooks (46) at both ends of the dog element (43), whereby
gear (41) shafts (42) of the toothed gear (40, 41) are driven by a transmission with a toothed belt (47) which is wound around a toothed drive wheel (48) mounted on the top and connected with the extension shaft (22), and below, around two toothed directional wheels (49) mounted on bearings symmetrically with respect to the plane (P-P) and around two horizontally spaced toothed reversing wheels (50) mounted on the gear (41) shafts (42).

15. The device of claim 1, wherein the air circuit (P) in the cooling module (C) is supplied by two evaporators (81) of a refrigeration unit (76), installed in parallel next to each other on the module side wall, the fans (77) of which are connected to the air blow ducts (78) routed above and along the axis of the front (2) and rear (1) racks, and whose bottoms (79) are perforated with holes.

16. The device of claim 15, wherein the diameters of the holes in the perforated bottoms (79) increase with the distance from the fan (77).
